(19) United States
(12) Patent Application Publication
(10) Pub. No.: US 2026/0087562 A1
(43) Pub. Date: Mar. 26, 2026

(54) SYSTEMS AND METHODS FOR REAL-TIME SCALABLE MANAGEMENT OF SUBSCRIPTION-BASED RESOURCE CONSUMPTION RECORDS IN A MULTI-TENANT SYSTEM

(71) Applicant: Zuora, Inc., Redwood City, CA (US)

(72) Inventors: Xin Yu LIU, Beijing (CN); Jianyu XIAO, Sichuan (CN); Song GAO, Beijing (CN); Shaohui SHI, Beijing (CN); Fang QI, Beijing (CN)

(21) Appl. No.: 18/893,583

(22) Filed: Sep. 23, 2024

(51) Int. Cl. G06Q 40/12

(52) U.S. Cl. CPC G06Q 40/12

(57) ABSTRACT

The multi-tenant system includes hardware processors that obtain subscription records including subscription identification parameters and preloaded resource parameters, generate preloaded resource objects based on the preloaded resource parameters, and obtain drawdown events from a drawdown event message queue. The drawdown events include drawdown event fields indicative of a consumption quantity and a first subset of subscription identification parameters of a particular subscription record. The hardware processors identify a particular preloaded resource object, perform a selective drawdown on the particular preloaded resource object, and publish a completed drawdown event within a completed drawdown message queue. The hardware processors further obtain consumption events from a consumption event message queue, the consumption events including consumption event fields indicative of the consumption quantity and the first subset or a second subset of the subscription identification parameters. The hardware processors compute a rating, and adjust the computed rating based on the completed drawdown event.

### TECHNICAL FIELD

This disclosure pertains to subscription-based resource consumption, and more particularly pertains to systems and methods for real-time scalable management of subscription-based resource consumption records within a multi-tenant system.

### BACKGROUND

Some subscriptions may be based on the amounts of resources subscribers consume. These resources may include tangible and/or intangible resources, such as data utilization, data storage, media, goods, raw materials, energy, system accesses, and/or time. Because resources may be variably consumed, systems and methods for managing subscription-based resource consumption records are needed.

### SUMMARY

A claimed solution rooted in computer technology overcomes problems specifically arising in the realm of computer technology. Embodiments of the present invention implement a consumption records management system within a multi-tenant system. The consumption records management system manages subscription-based resource consumption records by obtaining subscription records of subscriptions, obtaining consumption records, validating the consumption records, recording consumption and tracking consumption according to the validated consumption records.

Embodiments of the present invention provide preloading of resources and drawdown of preloaded resources, in parallel with computation of a rating. Implementing these parallel processes constitute computing improvements. These computing improvements included providing updated, real-time consumption information. Embodiments described herein provide efficient and flexible scaling to handle different volume of transactions, such as billions of transactions, in real-time. In addition, the separation of the aforementioned systems, namely, the rating computation system and the drawdown system, allow the rating computation system and the drawdown system to operate independently and to be scaled independently from each other. The consumption records management system efficiently streamlines management of variable subscription-based consumption records.

The consumption records management system of the present invention is an improvement over related systems. Currently, related systems are neither performant nor scalable for management of variable subscription-based consumption records. For example, these related systems fail to persist any recording of variable subscription-based consumption records, because these related systems fail to support features such as preloading of resources and/or drawdown of any preloaded resources. This means that up-to-date consumption information is largely unavailable.

In some embodiments of the present invention, the subscription records are generated during creation of a subscription. In some embodiments, each subscription record may include or otherwise be associated with one or more preloaded resource parameters which define preloaded resources. Each preloaded resource may represent an allocation of a particular resource that is available to be drawn down from. Each preloaded resource may be represented by a preloaded resource object. In some embodiments, validating the consumption records may include confirming that the consumption records belong to a subscription record. The consumption records management system may track consumption by drawing down a particular preloaded resource object after consumption of a particular resource. The consumption records management system may further determine any overage of the consumption, compute a rating corresponding to the overage, and execute a downstream workflow based on the rating. In some embodiments, an overage may be a quantity of consumption of a particular resource that was not covered by drawdown of a particular preloaded resource object. In some embodiments, a rating may include a payment amount corresponding to the overage. The downstream workflow may include generating an invoice or report.

Embodiments of the present invention implement a consumption records management system that includes a consumption recording system, a rating computation system, and a drawdown system. The consumption recording system may obtain subscription records and consumption records. In some embodiments, obtaining records may include accessing the records and/or extracting fields from the records. In some embodiments, the subscription records may include any or all of subscription identification parameters, preloaded resource parameters, and drawdown and overage parameters. The consumption recording system validates the consumption records. After validating the consumption records, the consumption recording system generates a consumption object corresponding to each validated consumption record and persists the consumption object within a consumption database. The consumption recording system publishes a drawdown event to the drawdown system and publishes a consumption event to the rating computation system. The drawdown event and the consumption event may be based on and/or correspond to at least a portion of the persisted consumption object, meaning that both the drawdown event and the consumption event may include a portion of fields within the persisted consumption object.

The drawdown event and the consumption event may be published via separate message queues, through which the drawdown event and the consumption event are ingested into the rating computation system and the drawdown system, respectively. In this manner, the separate message queues may scale independently and further facilitate the independent scaling of the drawdown system and the rating computation system.

The rating computation system obtains the subscription records and the consumption event, computes a rating from the subscription records and the consumption event, and records the rating within a rating database. A rating may be an incurred expense for consumption of a resource as indicated by the consumption event. For example, a rating may be $10 for 25 kWh of electricity consumed.

Separately, the drawdown system obtains the subscription records and generates preloaded resource objects based on preloaded resource parameters within the subscription records. The drawdown system manages the preloaded resource objects. The drawdown system obtains the drawdown event. The drawdown system draws down a particular preloaded resource object in order to update an available amount of preloaded resources in response to a drawdown event.

In some embodiments, following a successful drawdown, the drawdown system publishes a completed drawdown event to the rating computation system, which indicates an amount of drawdown of any preloaded resource objects and/or an amount of overage. In other words, the completed drawdown event indicates a successfully applied drawdown against any preloaded resource objects. Upon receiving the completed drawdown event, the rating computation system may recompute an adjusted rating, which includes only the overage which corresponds to the portion of the drawdown event that was not applied against any preloaded resources. This prevents double charging for resource consumption. The adjusted computed rating may be stored within the rating database and may be applied to a downstream workflow, such as an invoice or report.

As previously described, the consumption object, or at least a portion thereof. is published to both the drawdown system and the rating computation system in the form of different events, the drawdown event and the consumption event. The drawdown event and the consumption event are published in separate queues. The technical advantages of publishing the consumption object to both systems include independent scaling and/or operation of the drawdown system and the rating computation system. Independent scaling is particularly advantageous because a large volume of consumption records may be obtained by the consumption recording system within a short duration of time, such as hundreds of thousands of consumption records within an hour. Additionally, priorities of resource preloading and rating computation may be different. Depending on the different priorities, a speed or schedule in which the consumption events are ingested into the drawdown system and the rating computation system may be adjusted separately. For example, a number of consumers, which may include applications such as clients that read the consumption events, may be adjusted independently in each queue. Likewise, a number of hosts of the applications, and/or a number of threads within each host, may be adjusted independently in each queue. Additionally or alternatively, a number of partitions corresponding to the message queues, and/or a number of brokers over which the partitions are distributed, may be adjusted independently in the separate message queues. Another technical advantage of separately publishing the consumption event to both systems is that separate payloads or separate representations of the consumption object may be ingested into the drawdown system and the rating computation system. The separate payloads may represent different subsets of the consumption object that are relevant to the drawdown system and the rating computation system. In some examples, the payload to the drawdown system may include consumption allocation information, which may be absent from the payload to the rating computation system.

Additionally, the drawdown system itself is an elegant computing solution which improves a computing technology for resource consumption records management in recurring subscriptions. The drawdown system enables preloading of subscription-based resources, via preloaded resource objects, and constant, real-time tracking of statuses of the preloaded resource objects. In this manner, the drawdown system may provide up-to-date statuses of the preloaded resource objects, including any drawdowns and/or overages.

Embodiments of the invention implement a multi-tenant system. The multi-tenant system includes one or more hardware processors; and memory storing computer instructions. In some embodiments, the multi-tenant system includes a rating computation system, and a drawdown system. The computer instructions, when executed by the one or more hardware processors, are configured to perform, at the drawdown system, obtaining one or more subscription records, the one or more subscription records comprising subscription record fields indicative of subscription identification parameters and preloaded resource parameters, the subscription identification parameters defining a subscriber and a particular subscription resource, and the preloaded resource parameters defining preloaded resource objects that have a preloaded allocation of the particular subscription resource. At the drawdown system, the computer instructions, when executed by the one or more hardware processors, are configured to perform generating the one or more preloaded resource objects based on the preloaded resource parameters, obtaining one or more drawdown events from a drawdown event message queue, each of the one or more drawdown events each comprising drawdown event fields indicative of a consumption quantity and a first subset of the subscription identification parameters of a particular subscription record; identifying a particular preloaded resource object to be drawn down from based on the drawdown event; performing a selective drawdown on the particular preloaded resource object according to the one or more drawdown events; and publishing a completed drawdown event within a completed drawdown message queue in response to performing of the selective drawdown. At the rating computation system, the computer instructions, when executed by the one or more hardware processors, are configured to perform obtaining the one or more subscription records; obtaining one or more consumption events from a consumption event message queue, each of the one or more consumption events comprising consumption event fields indicative of the consumption quantity and the first subset or a second subset of the subscription identification parameters of the particular subscription record; computing a rating based on the one or more consumption events and the particular subscription record; obtaining the completed drawdown event; and adjusting the computed rating based on the completed drawdown event.

In some embodiments, the computer instructions when executed by the one or more hardware processors configured to perform: independently adjusting a throughput of events transmitted through the drawdown event message queue and the consumption event message queue.

In some embodiments, the drawdown event fields comprise a charge identifier field indicative of the particular subscription resource, and the computer instructions when executed by the one or more hardware processors configured to perform: partitioning the drawdown event message queue and the consumption event message queue into separate partitions based on the charge identifier field.

In some embodiments, the subscription records comprise termed subscriptions or evergreen subscriptions.

In some embodiments, the identifying of the particular preloaded resource object comprises obtaining a drawdown unit of measure (UOM) mapped by the drawdown event; and determining the particular preloaded resource object having a preloading UOM that matches the drawdown UOM.

In some embodiments, the adjusting of the computed rating based on the completed drawdown event is performed in a roll forward manner, the adjusting of the computed rating comprising appending an adjustment entry which negates the computed rating and an adjusted entry indicating an adjusted rating.

In some embodiments, the performing of the selective drawdown on the particular preloaded resource object comprises: determining an available quantity of the subscription resource recorded within the particular preloaded resource object; and deducting the available quantity by the consumption quantity.

In some embodiments, the performing of the selective drawdown on the particular preloaded resource object comprises: determining that the consumption quantity exceeds the available quantity; and in response to determining that the consumption quantity exceeds the available quantity, recording an overage corresponding to the difference between the consumption quantity and the available quantity, wherein the completed drawdown event comprises the overage.

In some embodiments, the adjusting of the computed rating comprises adjusting the computed rating to an adjusted rating indicative of the overage.

In some embodiments, the performing of the selective drawdown on the particular preloaded resource object comprises: determining that the consumption quantity exceeds the available quantity; and in response to determining that the consumption quantity exceeds the available quantity: identifying any other particular preloaded resource objects to be drawn down from based on the drawdown event; and performing a selective drawdown of the any other particular preloaded resource objects according to the consumption quantity.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1 is a block diagram of a network system for providing cloud-based software-as-a-service (SAAS) services of a multi-tenant system to multiple tenants, according to some embodiments of the present invention.

FIG. 2 is a block diagram illustrating details of a consumption records management system, in accordance with some embodiments of the present invention.

FIG. 3 illustrates an example subscription record, in accordance with some embodiments of the present invention.

FIG. 4 illustrates an example consumption record, in accordance with some embodiments of the present invention.

FIG. 5 is a block diagram illustrating details of a consumption recording system, in accordance with some embodiments of the present invention.

FIG. 6 is a block diagram illustrating details of a consumption records validating engine, in accordance with some embodiments of the present invention.

FIG. 7 illustrates an example consumption object, in accordance with some embodiments of the present invention.

FIG. 8 is a block diagram illustrating details of a drawdown system, in accordance with some embodiments of the present invention.

FIG. 9 illustrates an example preloaded resource object, in accordance with some embodiments of the present invention.

FIG. 10 is a block diagram illustrating details of a rating computation system, in accordance with some embodiments of the present invention.

FIG. 11 illustrates an example rating object, in accordance with some embodiments of the present invention.

FIG. 12 is an example flow diagram that describes interactions among the consumption recording system, the drawdown system, and the rating computation system, in accordance with some embodiments of the present invention.

FIG. 13 is a flowchart of a method of creating preloaded resource objects by the drawdown system, in accordance with some embodiments of the present invention.

FIG. 14 is a block diagram illustrating details of a computing system.

### DETAILED DESCRIPTION

A claimed solution rooted in computer technology overcomes problems specifically arising in the realm of computer technology. In accordance with some embodiments of the present invention, a consumption records management system is configured to manage consumption records by obtaining subscription records of subscriptions, obtaining consumption records, validating the consumption records, tracking consumption, and recording consumption of subscription based resources according to the validated consumption records. In some embodiments, each subscription record may include one or more preloaded resource parameters which define preloaded resources. Each preloaded resource may represent an allocation of a particular resource that is available to be drawn down from. The recording of consumption may occur via two parallel processes, namely, a drawdown process applied to the preloaded resources and a rating computation process triggered by obtaining a consumption record.

The consumption records management system includes a consumption recording system, a rating computation system, and a drawdown system. The consumption recording system obtains consumption records and subscription records, validates the consumption records, generates a consumption object that represents the validated consumption record, and notifies the rating computation system and the drawdown system regarding the validated consumption record. The notifying may include publishing a drawdown event to the drawdown system and publishing a consumption event to the rating computation system. The drawdown event and the rating computation event contain at least a subset of fields within the consumption object. The drawdown event contains relevant fields for the drawdown system to perform a drawdown of a particular preloaded resource object, and the rating computation event contains relevant fields for the rating computation system to compute a rating.

The rating computation system may obtain the subscription records and the consumption event. The rating computation system may compute a rating according to the consumption event received from the consumption recording system. In some embodiments, the rating is a cost corresponding to a quantity consumed of a particular resource.

The drawdown system may obtain the subscription records and the drawdown event. The drawdown system may generate preloaded resource objects based on preloaded resource parameters within the subscription records. The drawdown system may identify, from the drawdown event, a particular preloaded resource object to draw down from. The drawdown system may draw down the particular preloaded resource object according to a quantity consumed as indicated within the drawdown event. The drawdown system may publish a completed drawdown event to the rating computation system. The completed drawdown event may indicate an amount of drawdown and/or any overage. The overage may correspond to a portion of the quantity consumed that was not applied against any preloaded resource object. In some embodiments, an overage may be caused by depletion and insufficiency of the preloaded resource objects. The rating computation system may recompute the rating according to the completed drawdown event. In some embodiments, the drawdown system and the rating computation system operate at least partially in parallel.

As previously indicated, the consumption recording system obtains subscription records and consumption records. The consumption recording system validates the consumption records to verify that the consumption records belong to a particular subscription record. The consumption recording system compares a subset of fields in the consumption records with corresponding fields in the subscription records, in order to identify a particular subscription record that has a matching subset of fields for each consumption record. If no subscription record is identified, then the consumption recording system outputs a flag indicating that the validation failed.

In some embodiments, the subscription records may include any or all of subscription identification parameters, preloaded resource parameters, and drawdown and overage parameters. The subscription identification parameters may include an account identifier, subscription identifier, charge identifier, charge unit of measure (UOM), subscription start date, any subscription end date, a subscription charge model, a subscription type, and/or other relevant information defining a subscription record. The account identifier identifies a subscriber (e.g., user) of the subscription. The subscription identifier, charge identifier, and/or the charge UOM, identify a product or service of the subscription. Any of the account identifier, subscription identifier, charge identifier, and/or the charge UOM may be used to validate a particular consumption record to ensure that the particular consumption record actually refers to a particular subscription record. In some embodiments, a subscription charge model may be flat fee, per unit, volume, or tiered pricing. In some embodiments, a subscription type may be a termed subscription or an evergreen subscription. An evergreen subscription has no definite subscription end date.

In some embodiments, the preloaded resource parameters define aspects of preloaded resources. Preloaded resources may be instantiated during the creation of a subscription record, and may be represented as a preloaded resource object. A preloaded resource object, in some embodiments, may represent an allocation of a particular resource that may be drawn down from. The preloaded resource parameters may include any or all of a preloaded resource charge type (e.g., recurring or one-time), a preloaded resource charge model (e.g., flat fee, per unit, volume, or tiered pricing), a preloaded resource list price as defined by a currency and a frequency of payment (e.g., $200/month), a preloaded resource billing duration which specifies a duration during which the list price is charged (e.g., annual), a preloaded resource amount which corresponds to a starting amount of a particular allocated resource, the preloaded resource UOM, which is a unit of measure of the preloaded resource (e.g., kilowatt-hours (kWh) of electricity).

In some embodiments, the drawdown and overage parameters define aspects of drawdown of a particular preloaded resource and overage computations. The drawdown and overage parameters include a drawdown charge type, a drawdown charge model, an overage list price, a drawdown UOM, and/or a billing period that designates how often billing occurs. The drawdown UOM may be used to identify a particular preloaded resource object that has a preloaded object UOM matching the drawdown UOM. In this manner, a particular preloaded resource object to draw down from is selected.

In some embodiments, each consumption record includes a consumption account identifier, a consumption subscription identifier, a consumption charge identifier, a consumption date and/or time, a quantity, and/or a consumption UOM of a particular consumption record. The consumption recording system obtains a consumption record, validates the consumption record, and generates a consumption object that includes at least a subset of the validated consumption record. In some embodiments, the validation of the consumption record may include validating any of the aforementioned fields of the consumption record such as the consumption account identifier, the consumption subscription identifier, the consumption charge identifier, and/or the consumption UOM associated with the consumption record. The validating of the consumption account identifier, consumption subscription identifier, the consumption charge identifier, and/or the consumption UOM may include verifying that the aforementioned fields belong to a subscription record. In other words, the validating may include verifying that the aforementioned fields within the consumption record match the fields corresponding to account identifier, the subscription identifier, the charge identifier, and the charge UOM within a particular subscription record.

The consumption recording system, after generating the consumption object, persists the consumption object within a consumption database, publishes a drawdown event to the drawdown system and publishes a consumption event to the rating computation system. The drawdown event and the consumption event may each include the fields within the persisted consumption object, or a portion thereof. In some embodiments, the drawdown event includes the consumption subscription identifier, the consumption time, the quantity, the consumption charge identifier, and the drawdown UOM. In some embodiments, the consumption event includes the consumption account identifier, the consumption subscription identifier, the consumption charge identifier, the consumption date, the quantity, and the consumption UOM.

The drawdown event and the consumption event may be published via separate message queues, through which the drawdown event and the consumption event are ingested into the rating computation system and the drawdown system, respectively. In this manner, the separate message queues may scale independently.

The rating computation system computes a rating based on the consumption event, and records the rating within a rating database. A rating may be an incurred expenditure corresponding to consumption as indicated by the consumption event. For example, a rating may be $10 for 25 kWh of electricity consumed. Separately, the drawdown system manages any preloaded resource objects. The preloaded resource objects may be updated to reflect current available amounts of preloaded resources following drawdowns which occur in response to a drawdown event.

In some examples, a particular preloaded resource object may have an insufficient available balance which is less than a consumption amount indicated by the drawdown event. The drawdown system may deplete the particular preloaded resource object, which draws down the available amount of the particular resource to zero. Upon the available amount decreasing to zero, drawdown for that particular preloaded resource object may be terminated. The drawdown system may then draw down balances from any other applicable preloaded resource objects. The drawdown system may record, within a preloaded resource database, any drawdowns of preloaded resource objects and/or overages which include drawdown events that were not applied against any preloaded resources. The drawdown system may then transmit a completed drawdown event to the rating computation system in order for the rating computation system to recompute the rating.

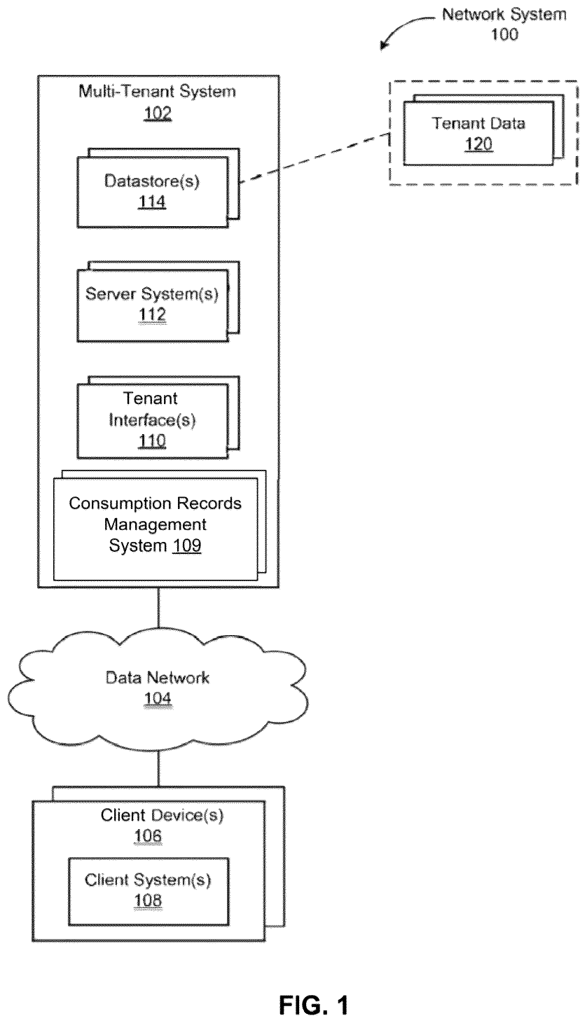

FIG. 1 is a block diagram of an example network system 100 for providing cloud-based software-as-a-service (SAAS) services of a multi-tenant system 102 to multiple tenants according to some embodiments. The teachings of FIG. 1 may be implemented in conjunction with any of the embodiments herein. Examples of cloud-based SAAS services include data storage, data processing, and business-oriented applications. In some embodiments, each tenant may be a subscription provider of resources (e.g., an internet service provider, a home security system and/or service provider, a cellular phone service provider, or entertainment content provider). Each tenant may additionally or alternatively include a group of one or more users (e.g., individuals, business entities, customers of the business entities, systems) who share access to the cloud-based services. In one embodiment, a tenant includes a service entity such as AT&T, Netflix, Verizon, and/or the like. A tenant may provide a subset of products or services of a larger entity. For example, AT&T internet products may be a particular tenant, and AT&T security products may be another tenant. In some embodiments, the cloud-based SAAS services include managing subscriber records, product and/or service consumption information, billing information, payment information, and/or the like.

The network system 100 includes the multi-tenant system 102 coupled via a data network 104 (e.g., a set of one or more public and/or private, wired and/or wireless networks) to client devices 106. The multi-tenant system 102 includes shared resources to host the cloud-based SAAS services to the tenants. The shared resources may include processors, memory, virtual systems, services, application programs, load balancers, firewalls, and/or the like. As shown, the multi-tenant system 102 includes tenant interfaces 110, server systems 112, datastores 114, and a consumption records management system 109. Each of the client devices 106 includes a client system 108 that accesses the cloud-based SAAS services hosted by the multi-tenant system 102. In some embodiments, the client system 108 may be operated by employees (e.g., administrator users) of the provider of the multi-tenant system 102. In some embodiments, the client systems 108 may be operated by employees of the tenant. In some embodiments, the client systems 108 may be operated by end users (subscribers) of the tenant's services.

Each client device 106 may include a desktop, laptop, notebook, tablet, personal digital assistant, smart phone, or other consumer electronic device incorporating one or more computer components. The client system 108 on each client device 106 may include hardware, software and/or firmware for communicating with the multi-tenant system 102 and accessing the cloud-based services it hosts. Examples of the client systems 108 may include web browsers, client engines, drivers, user interface components, proprietary interfaces, and/or the like.

The multi-tenant system 102 includes hardware, software and/or firmware to host the cloud-based services for the tenants. It will be appreciated that the multi-tenant system 102 may offer access to shared resources including systems and applications on shared devices and offer each tenant the same quality or varying qualities of service. In some embodiments, the multi-tenant system 102 does not use virtualization or instantiation processes. In some embodiments, a multi-tenant system 102 integrates several business computing systems into a common system with a view toward streamlining business processes and increasing efficiencies on a business-wide level.

In some embodiments, the multi-tenant system 102 includes a user interface tier of multiple tenant interfaces 110, a server tier of multiple server systems 112, and a datastore tier of multiple datastores 114 for the multiple tenants. In some embodiments, the tenant interfaces 110 includes graphical user interfaces and/or web-based interfaces to enable tenants to access the shared services hosted by the multi-tenant system 102. The tenant interfaces 110 may support load balancing when multiple tenants (and/or multiple customers of the tenants) try to access the multi-tenant system 102 concurrently. The tenant interfaces 110 may additionally or alternatively include an operator interface for use by a systems operator to configure or otherwise manage the multi-tenant system 102. In some embodiments, tenants may input one or more customized fields via the tenant interfaces 110 to be stored within datastores 114 and processed by the consumption records management system 109. In some embodiments, each tenant may be associated with a subset of the total tenant interfaces 110 for load balancing. In some embodiments, the tenant interfaces 110 may be used to input subscription records (e.g., an account identifier, a subscription identifier, a charge identifier, a time of consumption, a quantity, and/or a charge UOM).

In some embodiments, the server systems 112 include hardware, software and/or firmware to host the shared services for tenants. The hosted services may include tenant-specific business services or functions, including enterprise resource planning (ERP), customer relationship management (CRM), eCommerce, Human Resources (HR) management, payroll, financials, accounting, calendaring, order processing, subscription billing, inventory management, supply chain management (SCM), collaboration, sales force automation (SFA), marketing automation, contact list management, call-center support, web-based customer support, partner and vendor management systems, product lifecycle management (PLM), financial, reporting and analysis, and/or the like. Similar to the tenant interfaces 110, in some embodiments, the server systems 112 may support load balancing when multiple tenants (and/or multiple customers of tenants) try to access the multi-tenant system 102 concurrently. Further, in some embodiments, each tenant may be associated with a subset of the total server systems 112 for load balancing. In some embodiments, the consumption records management system 109 includes hardware, software and/or firmware to manage subscription-based resource consumption records in real-time and in a scalable manner. The consumption records management system 109 obtains consumption records, validates the consumption records, performs drawdown and computes a rating from the validated consumption records.

In some embodiments, tenant data 120 for each tenant may be stored in a logical store across one or more datastores 114. In some embodiments, each tenant uses a logical store that is not assigned to any predetermined datastores 114. Each logical store may contain tenant data 120 that is used, generated and/or stored as part of providing tenant-specific business services or functions. In some embodiments, the datastores 114 may include relational database management systems (RDBMS), MySQL relational database systems, object-based database systems, and/or the like. In some embodiments, tenant data 120 may be stored across multiple datastores 114, with each datastore dedicated to a particular service (e.g., managing customer records, managing subscription records which may include preloaded resource parameters, managing product and/or service consumption information, managing billing information, managing payment information, and/or the like). In some embodiments, any of the datastores 114 may store information regarding any updates or event notifications. In some examples, the tenant data 120 may originally have been ingested into the datastores(s) 114 from different sources (e.g., servers that host resources being provisioned by a tenant).

In some embodiments, although the datastores 114, the server systems 112, the tenant interfaces 110, and the consumption records management system 109 are shown separately, the separation is shown as merely an example of different aspects of the multi-tenant system 102. Any of the datastores 114, the server systems 112, the tenant interfaces 110, and the consumption records management system 109 may be integrated together and/or communicate or collaborate with one another. For example, the server systems 112 and the consumption records management system 109 may be integrated into a single system.

In some embodiments, the tenant data 120 may include subscription records, such as billing data, subscription status (e.g., active, canceled, suspended, re-activated), and/or geospatial data. Billing data may include billing invoice data (e.g., date of invoices and invoice amounts, overage charge dates and overage charge amounts), payment transaction data (e.g., date of payments, amount of payments), payment methods (e.g. credit card, debit card), payment plan (e.g., annual billing, monthly billing), and/or service plan information (e.g., the name of a service plan). Subscription records may also include a geographic region and/or location associated with a tenant, service, and/or subscriber. In some embodiments, the tenant data 120 may include usage data (e.g., account activity data), such as new subscriptions, changes to subscribed products and/or services, cancellation of one or more products and/or services, subscriptions to new products and/or services, application of discounts, loyalty program package changes (e.g., additional programs and/or services, special rates, and/or the like for loyal customers), reduction or increase of rates for products and/or services, consumption records, and/or cancellation of the application. In some embodiments, account activity may include usage of a product and/or product of a subscriber (e.g., what programs or content the subscriber actually watches, what services and what level of consumption the subscriber receives, quality of the product and/or services, and/or the like).

In some embodiments, the tenant data 120 may be stored in one or more data formats (or, simply, formats). For example, subscription tenant data may be stored in a particular format, and usage tenant data may be stored in another format. As used herein, formats may include data types, variable types, protocols (e.g., protocols for accessing, storing, and/or transmitting data). programming languages, scripting languages, data value parameters (e.g., date formats, string lengths), endpoint locations and/or types, schemas, and/or the like.

In some embodiments, the tenant data 120 may be stored in one or more monolithic databases and in one or more custom field databases. As stated above, the tenant data 120 may be stored in different records, e.g., a subscription record, a usage or consumption record, a billing record, etc. Each record may be managed by a particular record object, e.g., a subscription record object, a usage record object, a billing record object, etc. Each record object may manage a number of global fields that are common to all of the tenants. For example, the global fields for a subscription record for each and every tenant may include record ID, a username, a subscription identifier, etc. The global fields may be stored in the monolithic database. Notably, different tenants may require different additional fields to store information for different record objects. For example, a first tenant may require two custom fields for a subscription record and one custom field for a usage record. Another tenant may require three custom fields for a subscription record and four custom fields for a usage record. Data for these custom fields can be stored in a custom field database for each record for each tenant.

The monolithic and custom field databases of the multi-tenant system 102 may manage (e.g., create, read, update, delete) tenant data 120 using different formats, different protocols, etc. A monolithic application will control data storage in the monolithic database. A custom field service (microservice) will control data storage in the custom field database. It will be appreciated that as used herein, a “service” may be single service and/or a set of services (e.g., a cluster of services).

The data network (or, communication network) 104 may represent one or more computer networks (e.g., LAN, WAN, or the like) or other transmission mediums. The data network 104 may provide communication between the systems, engines, datastores, components, and/or devices described herein. In some embodiments, the data network 104 includes one or more computing devices, routers, cables, buses, and/or other network topologies (e.g., mesh, and the like). In some embodiments, the data network 104 may be wired and/or wireless. In various embodiments, the data network 104 may include the Internet, one or more wide area networks (WANs) or local area networks (LANs), one or more networks that may be public, private, IP-based, non-IP based, and so forth.

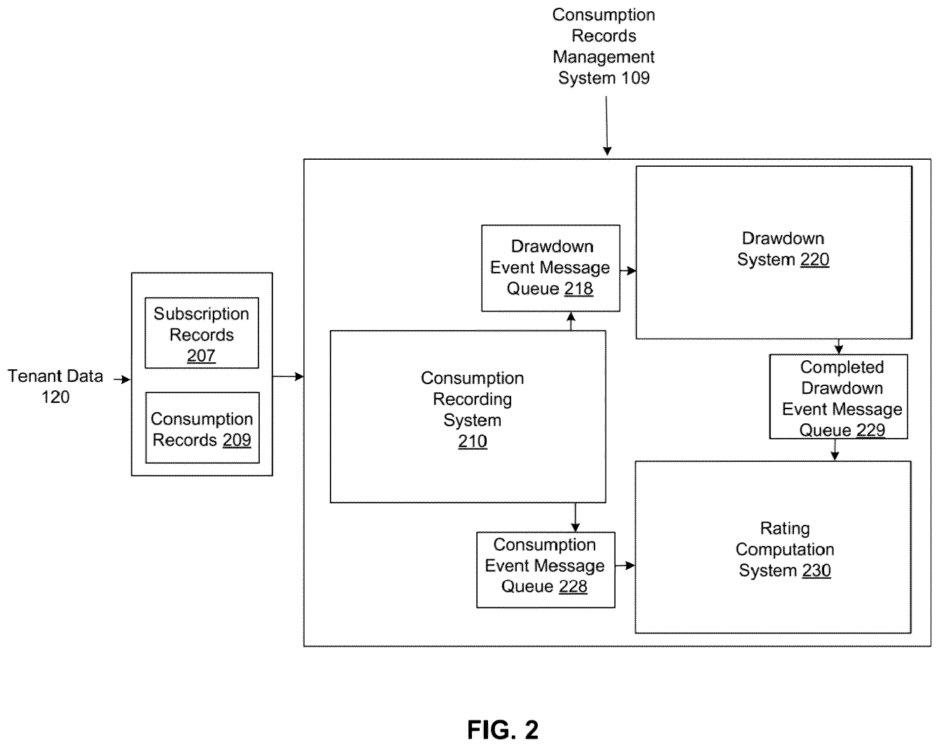

FIG. 2 is a diagram illustrating details of the consumption records management system 109, in accordance with some embodiments of the present invention. The consumption records management system 109 may include a consumption recording system 210, a drawdown system 220, and a rating computation system 230, which communicate with one another. Any of the consumption recording system 210, the drawdown system 220, and the rating computation system 230 may include database systems, services, and/or microservices. Although the foregoing describes the consumption recording system 210, the drawdown system 220, and the rating computation system 230 separately for ease of understanding, in some embodiments, the invention is not to be construed as limited to such. In some embodiments, the consumption recording system 210, the drawdown system 220, and the rating computation system 230 may be subsystems that may be at least partially integrated, for example, into one or more database systems.

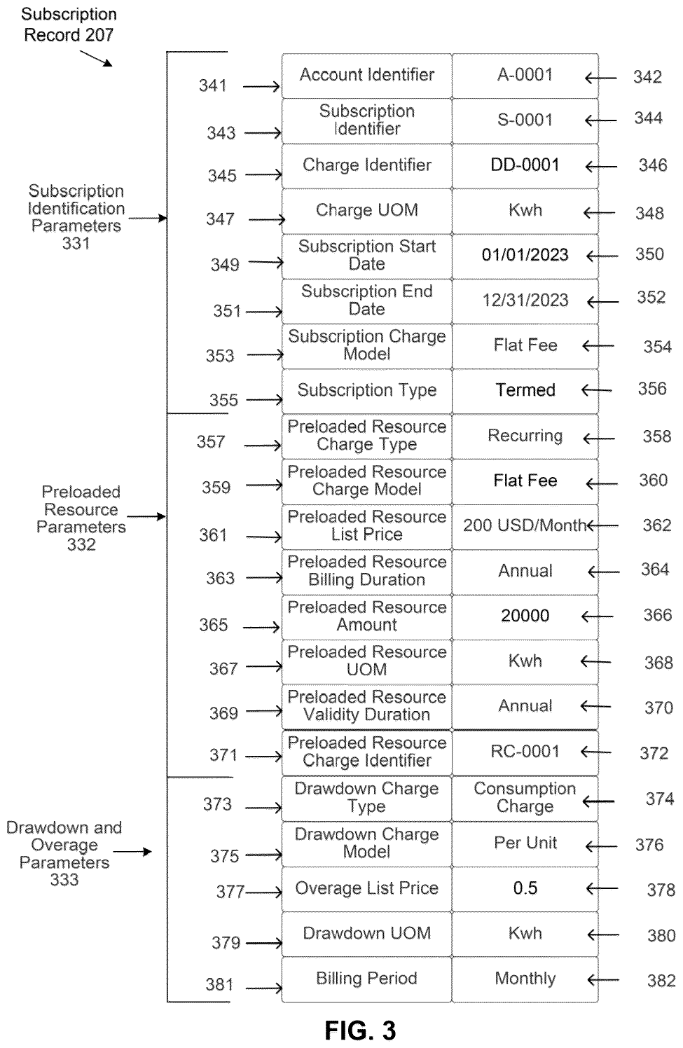

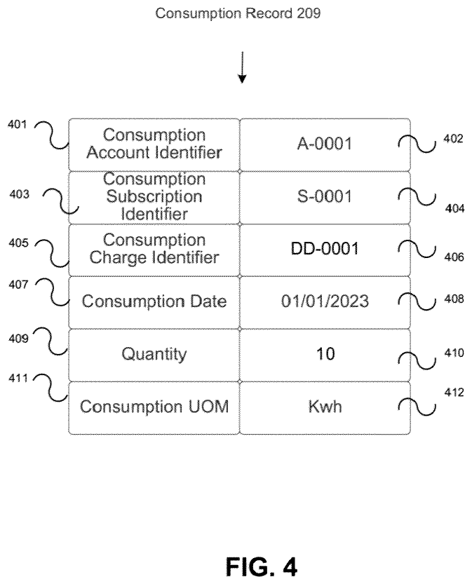

The consumption records management system 109 may obtain, from the tenant data 120 and/or via other external systems or Application Programming Interfaces (APIs), one or more subscription records 207 and one or more consumption records 209. In some embodiments, the subscription records 207 and consumption records 209 are part of the tenant data 120. An example of the subscription record 207 is illustrated in FIG. 3. An example of the consumption record 209 is illustrated in FIG. 4.

The consumption recording system 210 may obtain, from the tenant data 120 and/or via other external systems or APIs, the subscription records 207 and the consumption records 209. In some embodiments, the consumption recording system 210 may normalize at least a portion of the obtained subscription records 207 and/or the consumption records 209 to a uniform format. In some embodiments, the obtaining of the subscription records 207 and the consumption records 209 may include extracting relevant fields from the subscription records 207 and consumption records 209.

The consumption recording system 210 may validate at least a subset of fields within the consumption records 209. In some embodiments, the consumption recording system 210 may validate fields corresponding to a consumption account identifier, a consumption subscription identifier, a consumption charge identifier, and/or a consumption UOM within the consumption records 209. In some embodiments, this validation may encompass comparing the fields corresponding to the consumption account identifier, the consumption subscription identifier, the consumption charge identifier, and/or the consumption UOM of the consumption records 209 with corresponding fields of an account identifier, a subscription identifier, a charge identifier, and/or a charge UOM of the subscription records 207. If a particular subscription record that has matching fields is found, then the validation is successful. If no match is found, then the consumption recording system 210 may generate a flag indicating the failure to validate the consumption records 209.

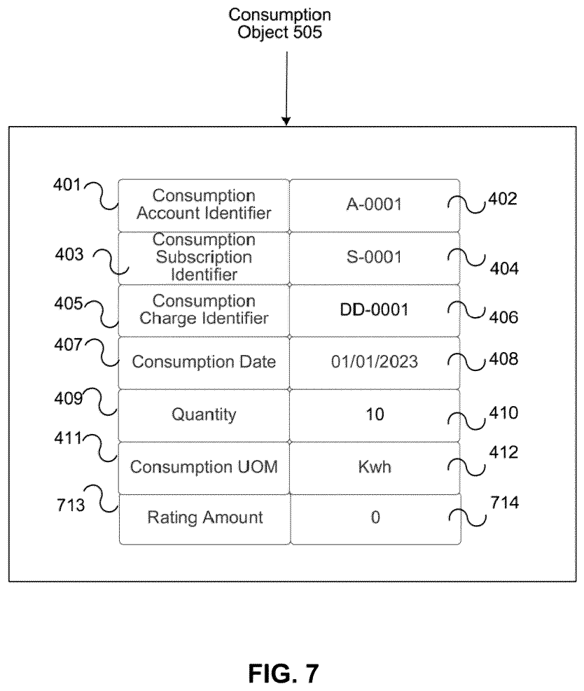

Following a successful validation, the consumption recording system 210 may record and persist the consumption records 209 as one or more consumption objects. An example consumption object is illustrated in FIG. 7. In some embodiments, the consumption objects may include fields within the consumption records 209, with an additional appended field corresponding to a rating. The consumption object may include a guided usage object which links the consumption object with a particular subscription record, which facilitates computation of a rating and/or identifying a particular preloaded resource to draw down from. The consumption object may be persisted within a datastore, such as a consumption database, file, or persistence layer.

The consumption recording system 210 may publish a consumption event and a drawdown event based on the consumption object. In some embodiments, the consumption event and the drawdown event may contain same or similar fields, but may be routed to different systems. In some embodiments, the drawdown event includes the consumption subscription identifier, the consumption time, the quantity, the consumption charge identifier, and the drawdown UOM. In some embodiments, the consumption event includes the consumption account identifier, the consumption subscription identifier, the consumption charge identifier, the consumption date, the quantity, and the consumption UOM. In some embodiments, the consumption event may contain pricing allocation data, such as how to allocate a consumption charge to obtain or adjust pricing information. The consumption event is transmitted to the rating computation system 230 via a consumption event message queue 228. The drawdown event is transmitted to the drawdown system 220 via a drawdown event message queue 218.

The rating computation system 230 may obtain the consumption event and the subscription records 207 to compute a rating, corresponding to an expense, incurred from the consumption event. In some embodiments, the rating computation system 230 may aggregate ratings from consumption events over a billing period (e.g., over a one-month period).

The drawdown system 220 may obtain the subscription records 207 and the drawdown event. The drawdown system 220 may generate one or more preloaded resource objects from preloaded resource parameters within the subscription records 207. The drawdown system 220 may identify a particular preloaded resource object to be drawn down from in response to the drawdown event based on the subscription identifier and the drawdown UOM of the drawdown event. The drawdown system 220 may draw down the identified particular preloaded resource object. The drawdown system 220 may perform drawdown asynchronously with and independent from computation of the rating by the rating computation system 230. Following a successful drawdown, the drawdown system 220 may publish a completed drawdown event to the rating computation system 230. The completed drawdown event may be published, via a completed drawdown event message queue 229, to the rating computation system 230. The completed drawdown event may include an account identifier, the preloaded resource UOM, any fields within the consumption object, and/or an amount of drawdown.

The completed drawdown event may trigger the rating computation system 230 to recompute a rating to avoid repeated charging for the consumption of a particular resource, if drawdown has already occurred for that particular resource. In some embodiments, the rating computation system 230 may recompute a rating in an append-only manner and/or a roll-forward, stateless manner. In some embodiments, the rating computation system 230 may retain the originally computed rating, and append another entry to the originally computed rating, In some embodiments, the rating computation system 230 may adjust the computed rating by appending an adjustment entry which negates the originally computed rating and append an adjusted entry indicating a recomputed rating. Recomputing in an append-only manner may be more efficient and consume fewer computing resources compared to deleting the originally computed rating and replacing it with the adjusted rating. During a billing period, the rating computation system 220 may receive completed drawdown events that fall under different scenarios. The completed drawdown events may indicate three different scenarios. In a first scenario, the completed drawdown event indicates that the consumption amount is completely covered by drawdown of the preloaded resources, and therefore there is no overage. In a second scenario, the completed drawdown event indicates that the consumption amount is only partially covered by drawdown of the preloaded resources, and therefore, there is an overage of an amount less than the originally computed rating. In a third scenario, the completed drawdown event indicates that the consumption amount is not covered at all by drawdown of the preloaded resources because the preloaded resources have been depleted. In the third scenario, the originally computed rating represents the overage, which does not need to be recomputed.

In an example of the first scenario, if the originally computed rating for consumption of a particular resource during a billing period were $10, then upon receiving the completed drawdown event indicating preloaded resources still available, the rating computation system 230 may append an adjusted entry of negative $10 to reverse the originally computed rating. In an example of the second scenario, upon receiving another consumption event, the rating computation system 230 may first determine a rating entry for the amount of the consumption. The drawdown system 220 may determine the overage amount, and the rating computation system 230 may reverse the original rating entry and append an adjusted rating, which is the recomputed rating of an amount corresponding to the overage. In an example of the third scenario, upon receiving another consumption event, the rating computation system 230 may first determine a rating entry for the amount of the consumption. If the drawdown system 220 indicates that all preloaded resources have been depleted, the rating computation system 230 may leave the originally computed rating unchanged. The rating computation system 230 may aggregate all recomputed ratings, and any original ratings that were left unchanged, through a billing period. In some embodiments, after an end of the billing period, the preloaded resource objects (e.g., the preloaded resource objects 805) may be replenished within the drawdown system 220. When the preloaded resource objects have been replenished, then the completed drawdown events would fall under the first scenario or the second scenario. When the preloaded resource objects have been depleted, then the completed drawdown events would fall under the third scenario.

FIG. 3 is a diagram illustrating an example of the subscription record 207. As previously indicated, the subscription record 207 may include any or all of subscription identification parameters 331, preloaded resource parameters 332, and drawdown and overage parameters 333. The subscription identification parameters 331 may include any or all of fields 342, 344, 346, 348, 350, 352, 354, and 356 which correspond to an account identifier 341, a subscription identifier 343, a charge identifier 345, a charge UOM 347, a subscription start date 349, a subscription end date 351, a subscription charge model 353, and a subscription type 355, respectively.

The account identifier 341 identifies a user of the subscription. The subscription identifier 343, the charge identifier 345, and/or the charge UOM 347, identify a product or service of the subscription. Any or all of the account identifier 341, the subscription identifier 343, the charge identifier 345, and/or the charge UOM 347 may be used to validate a particular consumption record to ensure that the particular consumption record actually refers to a particular subscription record. In some embodiments, the subscription charge model 353 may be flat fee, per unit, volume, or tiered pricing. In some embodiments, the subscription type 355 may be a termed subscription or an evergreen subscription. An evergreen subscription has no definite subscription end date.

The charge UOM 347 may be used to validate a consumption record. In particular, if a field corresponding to a consumption UOM of a consumption record matches the field 346 corresponding to the charge UOM 347 of the subscription record 207 of FIG. 3, the consumption record may be validated.

In some embodiments, the subscription identifier 343 and the charge identifier 345 are permissive rather than mandatory fields but the charge UOM 347 is a mandatory field. In other embodiments, the charge UOM 347 is a permissive rather than mandatory field, but the subscription identifier 343 and the charge identifier 345 are mandatory.

In some embodiments, the preloaded resource parameters 332 define aspects of preloaded resource objects. The preloaded resource parameters 332 may include any or all of fields 358, 360, 362, 364, 366, 368, 370, and 372 corresponding to a preloaded resource charge type 357, a preloaded resource charge model 359, a preloaded resource list price 361, a preloaded resource billing duration 363, a preloaded resource amount 365, a preloaded resource UOM 367, a preloaded resource validity duration 369, and a preloaded resource charge identifier 371. In some embodiments, the preloaded resource charge type 357 may be recurring or one-time. In some embodiments, the preloaded resource billing duration 363 specifies a duration during which the preloaded resource list price 361 is charged (e.g., annual). In some embodiments, the preloaded resource amount 365 corresponds to a starting amount of a particular allocated resource. In some embodiments, the preloaded resource UOM 367 may be a unit by which a preloaded amount of the preloaded resource (e.g., kilowatt-hours (kWh) of electricity) is measured. The preloaded resource UOM 367 may be used, together with the subscription identifier 343, to identify a particular preloaded resource object to draw down from.

The drawdown and overage parameters 333 may include any or all of fields 374, 376, 378, 380, and 382 corresponding to a drawdown charge type 373, a drawdown charge model 375, an overage list price 377, a drawdown UOM 379, and a billing period 381. In some embodiments, the preloaded resource charge type 357 may be recurring or one-time. In some embodiments, the preloaded resource charge model 359 may be flat fee, per unit, volume, or tiered pricing. In some embodiments, the preloaded resource list price 361 may be defined by a currency and a frequency of payment (e.g., $200/month). The drawdown charge type 373 and the drawdown charge model 375 may correspond to one or more criteria by which drawdown occurs. Here, the drawdown charge type 373 is a consumption charge, and the drawdown charge model 375 is per unit, in which one unit of consumption causes one unit of drawdown of a particular preloaded resource object. The overage list price 377 defines a price per unit of consumption in a scenario of an overage. Overages may occur if a preloaded resource object has been depleted. For example, if the entire balance of 5000 kWh of electricity within the preloaded resource object has been depleted, then any additional consumption may be charged according to the overage list price 377. The drawdown UOM 379 defines a particular unit of measure (e.g., kWh) by which drawdown of a particular resource is measured. The drawdown UOM 379 is used to identify a particular preloaded resource object to draw down from. The drawdown UOM 379 of the particular preloaded resource object matches the preloaded resource UOM 367 within the subscription record 209, which is kWh in FIG. 3. The billing period 381 defines how often a user is billed for a particular preloaded resource.

FIG. 4 illustrates an example of the consumption record 209, in accordance with some embodiments. The consumption record 209 may include fields 402, 404, 406, 408, 410, and 412, corresponding to a consumption account identifier 401, a consumption subscription identifier 403, a consumption charge identifier 405, a consumption date 407, a quantity 409, and a consumption UOM 411. In some embodiments, the consumption account identifier 401 identifies a particular account of a subscriber (e.g., user) that has consumed a particular resource. In some embodiments, the consumption subscription identifier 403 identifies a particular subscription identifier of the user. In some embodiments, the consumption charge identifier 405 identifies a particular charge identifier of the user. In some embodiments, the consumption charge identifier 405 identifies a specific product or service consumed. The consumption date 407 may also include a time of consumption. In some embodiments, the consumption UOM 411 identifies a unit of measure by which consumption of the particular resource is measured, here, kWh. During validation of the consumption record 209, the consumption recording system 210 may identify a particular subscription record, in which the fields 342, 344, 346, and 348 corresponding to the account identifier 341, the subscription identifier 343, the charge identifier 345, and/or the charge UOM 347 match with corresponding fields 402, 404, 406, and 412 corresponding to the consumption account identifier 401, the consumption subscription identifier 403, the consumption charge identifier 405, and/or the consumption UOM 411.

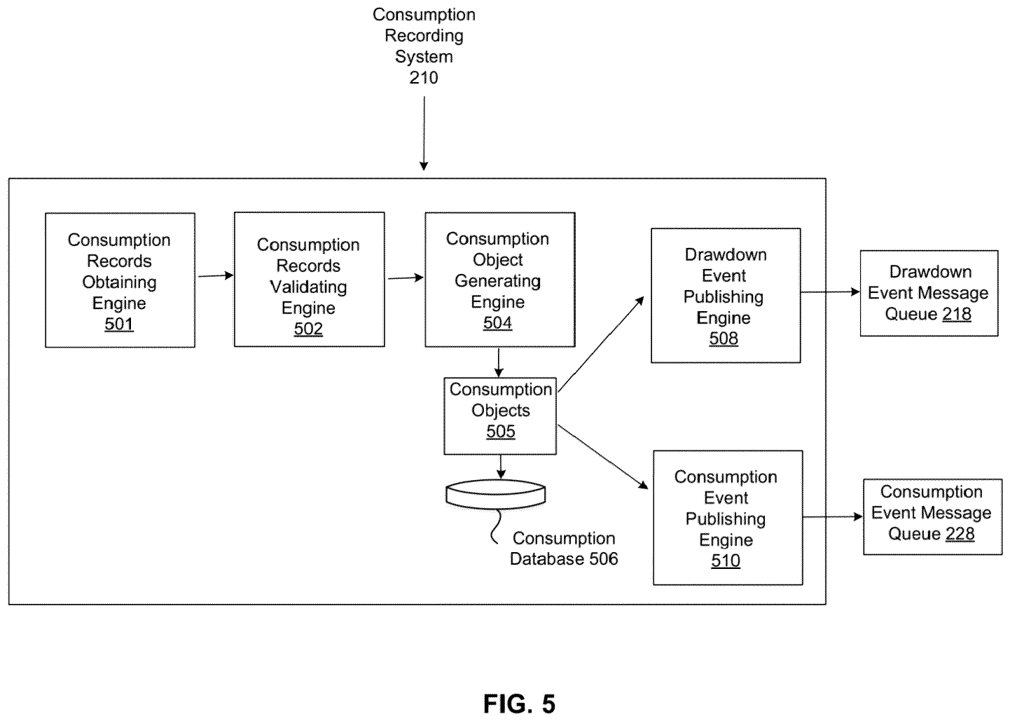

FIG. 5 is a block diagram illustrating details of the consumption recording system 210, in accordance with some embodiments of the present invention. In FIG. 5, the consumption recording system 210 includes a consumption records obtaining engine 501, a consumption records validating engine 502, a consumption object generating engine 504, a drawdown event publishing engine 508, and a consumption event publishing engine 510. Any of the referenced engines in FIG. 5 and in other FIGS. may include hardware, software and/or firmware capable of communicating with the tenant interfaces 110, the server systems 112, the datastores 114, the client devices 106, and/or other computing interfaces or APIs.

The consumption records obtaining engine 501 may include a consumer (e.g., client or application) that obtains the consumption records 209 as well as the subscription records 207. In some embodiments, the consumption records obtaining engine 501 may obtain the consumption records 209 and the subscription records 207 through an interface, such as the tenant interfaces 120 and/or one or more APIs such as RESTful APIs.

Referring back to FIG. 3 and FIG. 4, the consumption records validating engine 502 may validate the consumption records 209 by confirming a validity of the consumption account identifier 401, the consumption subscription identifier 403, the consumption charge identifier 405, and/or the consumption UOM 411. The confirming of the validity may include identifying a particular subscription record in which the fields 342, 344, 346, and 348 indicating the account identifier 341, the subscription identifier 343, the charge identifier 345, and/or the charge UOM 347 match corresponding fields 402, 404, 406, and 412 indicating the consumption account identifier 401, the consumption subscription identifier 403, the consumption charge identifier 405, and/or the consumption UOM 411. In some embodiments, the validation occurs sequentially, in which the consumption account identifier 401 is validated first, then the consumption subscription identifier 403, then the consumption charge identifier 405 and/or the consumption UOM 411. Upon validation, the consumption object generating engine 504 may generate one or more consumption objects 505, which may be guided objects that include the consumption charge identifier 405. An example consumption object is illustrated in FIG. 7. From the consumption charge identifier 405, relevant data for drawdowns and/or rating computation may be obtained from the subscription records 207. The consumption objects 505 may include any fields within the consumption records 209. In some embodiments, the consumption objects 505 include an additional field corresponding to a rating amount, which is used for the rating computation system 230 to compute a rating. Initially, the additional field may be set to zero. In some embodiments, the consumption objects 505 may be persisted into a consumption database 506.

From the consumption objects 505 persisted within the consumption database 506, the drawdown event publishing engine 508 may publish a drawdown event, to be ingested by the drawdown system 220 via the drawdown event message queue 218. The drawdown event may include any or all of information within the consumption objects 505. From the consumption objects 505 persisted within the consumption database 506, the consumption event publishing engine 510 may publish a consumption event, to be ingested by the rating computation system 230 via the consumption event message queue 228. The consumption event may include any or all of fields within the consumption objects 505. Fields within the consumption event may at least partially overlap with fields within the drawdown event. In some embodiments, the drawdown event includes any or all of the consumption subscription identifier 403, the consumption date 407, the quantity 409, the consumption charge identifier 405, and the drawdown UOM 379. The drawdown UOM 379 and the consumption subscription identifier 403 may be used, by the drawdown system 220, to identify a particular preloaded resource object. The particular preloaded resource object has a preloaded resource UOM (e.g., the preloaded resource UOM 367) that matches the drawdown UOM 379. In some embodiments, the consumption event includes any or all of the consumption account identifier 401, the consumption subscription identifier 403, the consumption charge identifier 405, the consumption date 407, the quantity 409, and the consumption UOM 411.

The drawdown event publishing engine 508 may publish drawdown events as part of the drawdown event message queue 218. The drawdown event message queue 218 may be implemented as part of a pipeline. The drawdown event message queue 218 may be separated by topics and/or partitions. The partitions may be based on charge identifiers. For example, drawdown events that are associated with different charge identifiers may be partitioned into separate partitions. Separate partitions may be transmitted in parallel. In some embodiments, the drawdown event message queue 218 may be implemented by a group of collaborative servers, which may be scalable depending on load. For example, during times of higher load, a number of collaborative servers may be dynamically increased. In other embodiments, to further facilitate scalability, a number of consumers or API handlers that read the drawdown events, a number of hosts of the consumers, and/or a number of threads within each host, may be adjusted independently. In other embodiments, a number of partitions, and/or a number of brokers over which the partitions are distributed, may also be adjusted. The consumption event message queue 228 may also operate according to same or similar principles. In this manner, a rate at which events are transmitted via the consumption event message queue 228 or via the drawdown event message queue 218. As previously indicated, keeping separate message queues for messages directed to the drawdown system 220 and the rating computation system 230 has benefits including independent scalability and operation of the drawdown system 220 and the rating computation system 230.

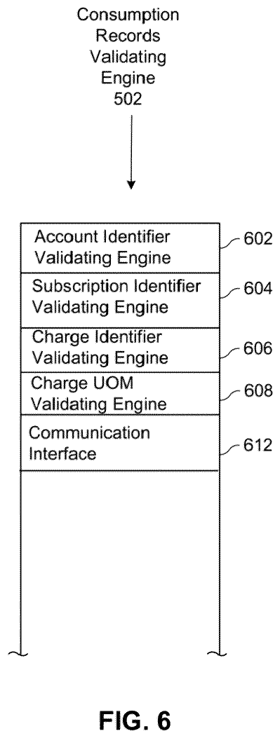

FIG. 6 is a block diagram illustrating the consumption records validating engine 502. In some embodiments, the consumption records validating engine 502 may obtain the subscription record 207 and the consumption record 209. The consumption records validating engine 502 may validate the consumption record 209 by identifying a particular subscription record (e.g., the subscription record 207 as illustrated in FIG. 3) that has certain matching fields as the consumption record 209. For example, the consumption records validating engine 502 may sequentially validate the fields 402, 404, 406, and 412 corresponding to the consumption account identifier 401, the consumption subscription identifier 403, the consumption charge identifier 405, and/or the consumption UOM 411 within the consumption record 209.

In some embodiments, the consumption records validating engine 502 includes an account identifier validating engine 602 which validates the consumption account identifier 401 by confirming that a particular subscription record (e.g., the subscription record 207) has the field 342 that matches the field 402. The field 342 is indicative of the account identifier 341 of the subscription record 207 while the field 402 is indicative of the consumption account identifier 401 of the consumption record 209.

In some embodiments, the consumption records validating engine 502 includes a subscription identifier validating engine 604 which validates the consumption subscription identifier 403 by confirming that the subscription record 207 has the field 344 which matches the field 404. In some embodiments, the consumption records validating engine 502 includes a charge identifier validating engine 606 which validates the consumption charge identifier 405 by confirming that the subscription record 207 has the field 346 matching the field 406. In some embodiments, the consumption records validating engine 502 includes a charge UOM validating engine 608 which validates the consumption UOM 411 by confirming that the subscription record 207 has the field 348 matching the field 412.

The communication interface 612 may include APIs and be configured to communicate with the tenant interfaces 110, the server systems 112, and/or the datastores 114.

FIG. 7 illustrates an example consumption object 505, in accordance with some embodiments of the present invention. In FIG. 7, the consumption object 505, as previously shown in FIG. 5, may include the fields 402, 404, 406, 408, 410 and 412 of the consumption record 209, and an additional field 714, which correspond to attributes of the consumption account identifier 401, the consumption subscription identifier 403, the consumption charge identifier 405, the consumption date 407, the quantity 409, the consumption UOM 411, and a rating amount 713. Thus, the consumption object 505 illustrated in FIG. 7 may have common fields as the consumption record 209 illustrated in FIG. 4. The consumption object 505 may include the additional field 714 corresponding to the rating amount 713, and the additional field 714 may be initially set to zero.

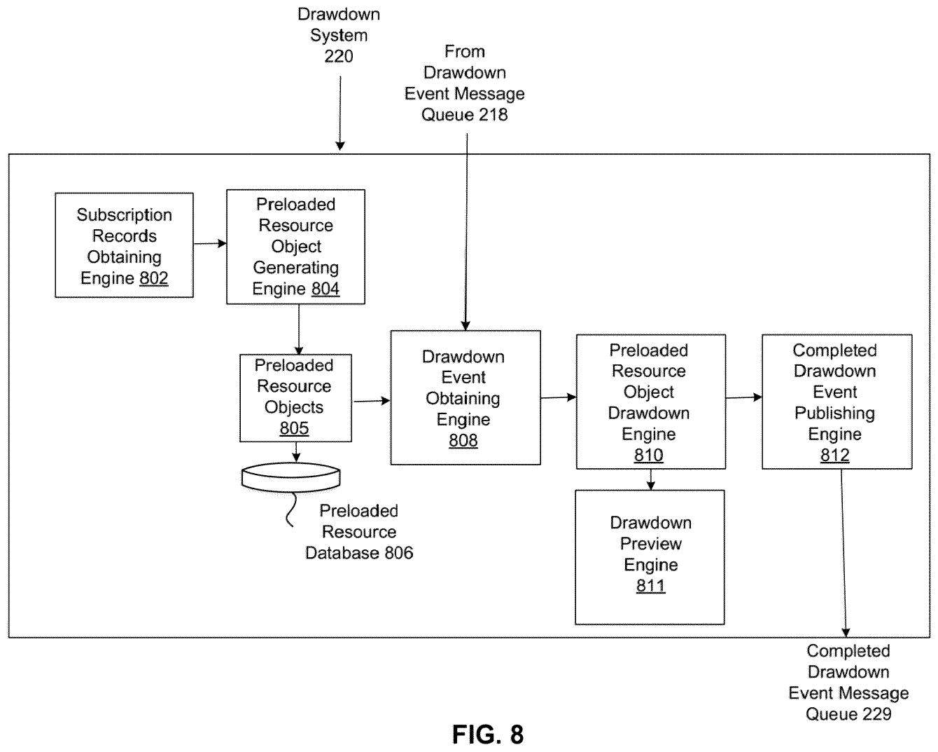

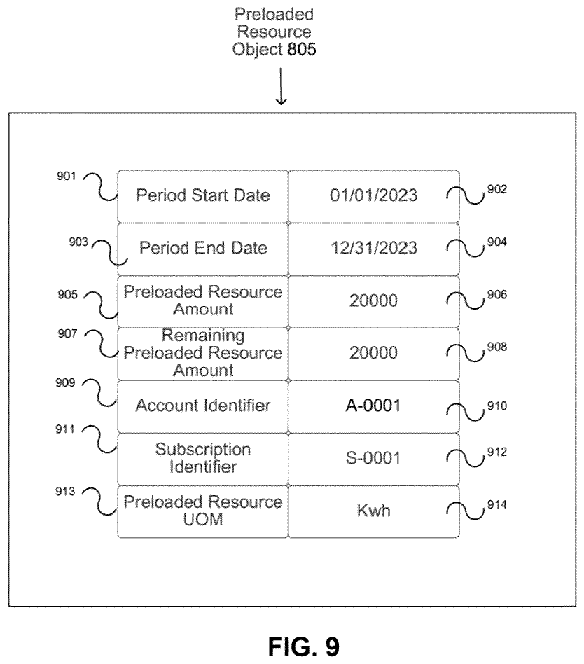

FIG. 8 is a diagram illustrating details of the drawdown system 220, in accordance with some embodiments of the present invention. The drawdown system 220 may include a subscription records obtaining engine 802, a preloaded resource object generating engine 804, a drawdown event obtaining engine 808, a preloaded resource object drawdown engine 810, a drawdown preview engine 811, and a completed drawdown event publishing engine 812. The subscription records obtaining engine 802 may obtain the subscription records 207. In some embodiments, obtaining the subscription records 207 may include extracting relevant fields, such as fields corresponding to the preloaded resource parameters 332 illustrated in FIG. 3. In some embodiments, the subscription records 207 may be obtained from a separate computing component that is used to define the subscription records 207. From the subscription records 207, the preloaded resource object generating engine 804 may generate preloaded resource objects 805 according to any or all of the preloaded resource parameters 332. In some embodiments, the preloaded resource objects 805 may have fields corresponding to at least a subset of the preloaded resource parameters 332. The preloaded resource objects 805 may be stored or persisted within a preloaded resource database 806. An example of the preloaded resource object 805 is illustrated in FIG. 9.

The drawdown event obtaining engine 808 may include one or more consumers that obtain the drawdown event from the drawdown event message queue 218. The drawdown event obtaining engine 808 may transmit the drawdown event to the preloaded resource object drawdown engine 810. The preloaded resource object drawdown engine 810 may identify, out of the preloaded resource objects 805 persisted within the preloaded resource database 806, a particular preloaded resource object to draw down from, based on the consumption subscription identifier 403 and the drawdown UOM 379 indicated by the drawdown event. The preloaded resource object drawdown engine 810 may drawdown the particular preloaded resource object, which updates an available amount of resources within the particular preloaded resource object. The updating of the available balance may be performed in an append-only manner.

In some embodiments, the preloaded resource object drawdown engine 810 is prohibited from causing the particular preloaded resource object to reach a negative balance. If the particular preloaded resource object is depleted without accounting for the entire consumption amount indicated within the drawdown event, the preloaded resource object drawdown engine 810 may determine any other preloaded resource objects to draw down from to cover the remaining consumption amount that is unaccounted for. If no other preloaded resource objects are available, then there is an overage corresponding to the remaining consumption amount.

The drawdown preview engine 811 may generate a preview which includes an updated available amount of a resource following the drawdown by the preloaded resource object drawdown engine 810. The generating of the preview may be in response to a request or query, or may occur following a drawdown which updates the available amount of a resource within a particular preloaded resource amount. The drawdown preview engine 811 enables a live snapshot of updated available amounts of a resource.

After the preloaded resource object drawdown engine 810 has drawn down any available preloaded resource objects, the completed drawdown event publishing engine 812 may publish a completed drawdown event to the rating computation system 230 via the completed drawdown event message queue 229, so that the rating computation system 230 ensures that a subscriber is not repeatedly charged for consumption of a particular resource, if draw down has already occurred. Any principles previously described for the drawdown event message queue 218 and/or the consumption event message queue 228 may also be applicable to the completed drawdown event message queue 229.

FIG. 9 illustrates an example of the preloaded resource object 805, as previously described in FIG. 8 and generated by the preloaded resource object generating engine 804. The preloaded resource object 805 may include fields 802, 804, 806, 808, 180, 812, and 814, corresponding to a subscription period start date 801, a subscription period end date 803, preloaded resource amount 805, a remaining preloaded resource amount 807, an account identifier 809, a subscription identifier 811, and a preloaded resource UOM 813.

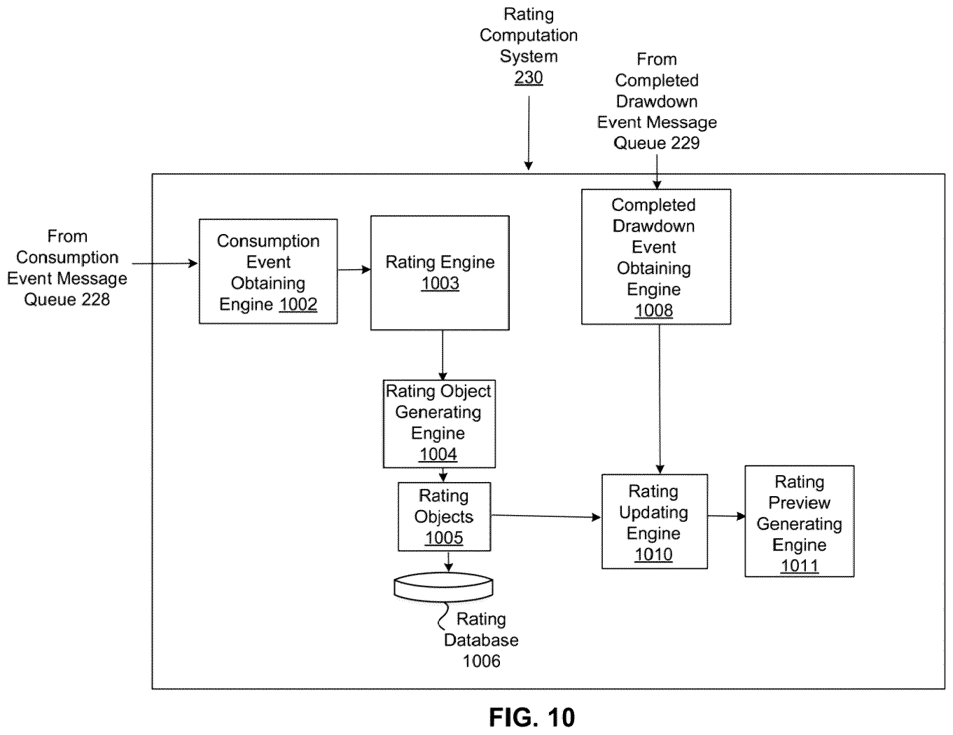

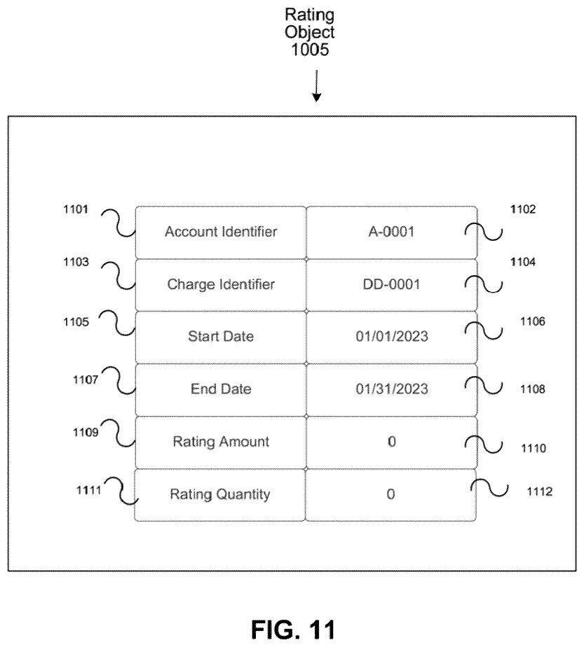

FIG. 10 is a diagram illustrating details of the rating computation system 230, in accordance with some embodiments of the present invention. The rating computation system 230 may include a consumption event obtaining engine 1002, a rating consumption engine 1003, a rating object generating engine 1004, a completed drawdown event obtaining engine 1008, and a rating preview engine 1011. The consumption event obtaining engine 1002 may include one or more consumers that obtain a consumption event from the consumption event message queue 228 and published by the consumption recording system 210. The consumption event obtaining engine 1002 may also obtain the subscription records 207. The consumption event obtaining engine 1002 may transmit the consumption event and the subscription records 207 to the rating consumption engine 1003. The rating consumption engine 1003 may compute a rating, based on the consumption event and based on the overage list price 377 within the drawdown and overage parameters 333 of the subscription records 207. In some embodiments, the rating consumption engine 1003 may aggregate ratings for a given billing period. The rating object generating engine 1004 may generate a rating object 1005 based on the ratings computed, if no rating object is currently available for a given billing period. The generated rating object 1005 may be stored in a persistence layer. The persistence layer may be within a rating database 1006, or separate from the rating database 1006. If a rating object is available for a given billing period, the rating object generating engine 1004 may load the available rating object from a persistence layer and modify a rating of the available rating object. An example implementation of the rating object 1005 is illustrated in FIG. 11.

The completed drawdown event obtaining engine 1008 may obtain, from the completed drawdown event, an indication of an amount of a drawdown and/or of an overage. The completed drawdown event obtaining engine 1008 may transmit the completed drawdown event to the rating consumption engine 1003. The rating consumption engine 1003 may update the previously computed rating to prevent a repeated charge. The rating consumption engine 1003 may store a result of the updated computed rating within the rating database 1006. The rating preview engine 1011 may generate a preview which includes the updated rating following recomputation by the rating consumption engine 1003. The generating of the preview may be in response to a request or query, or may occur following a rating recomputation. The rating preview engine 1011 enables a live snapshot of an updated rating.

FIG. 11 illustrates an example of the rating object 1005, as previously described in FIG. 10 and generated by the rating object generating engine 1004. The rating object 1005 includes fields 1102, 1104, 1106, 1108, 1110, and 1112, which correspond to attributes of an account identifier 1101, a charge identifier 1103, a start date 1105 of a subscription, an end date 1107 of a subscription, a rating amount 1109, and a rating quantity 1111. Here, the rating amount 1109 and the rating quantity 1111 may, upon generation of the rating object 1005, be set to zero, The rating object 1005 may capture a cumulative rating based on all the consumptions within a billing period.

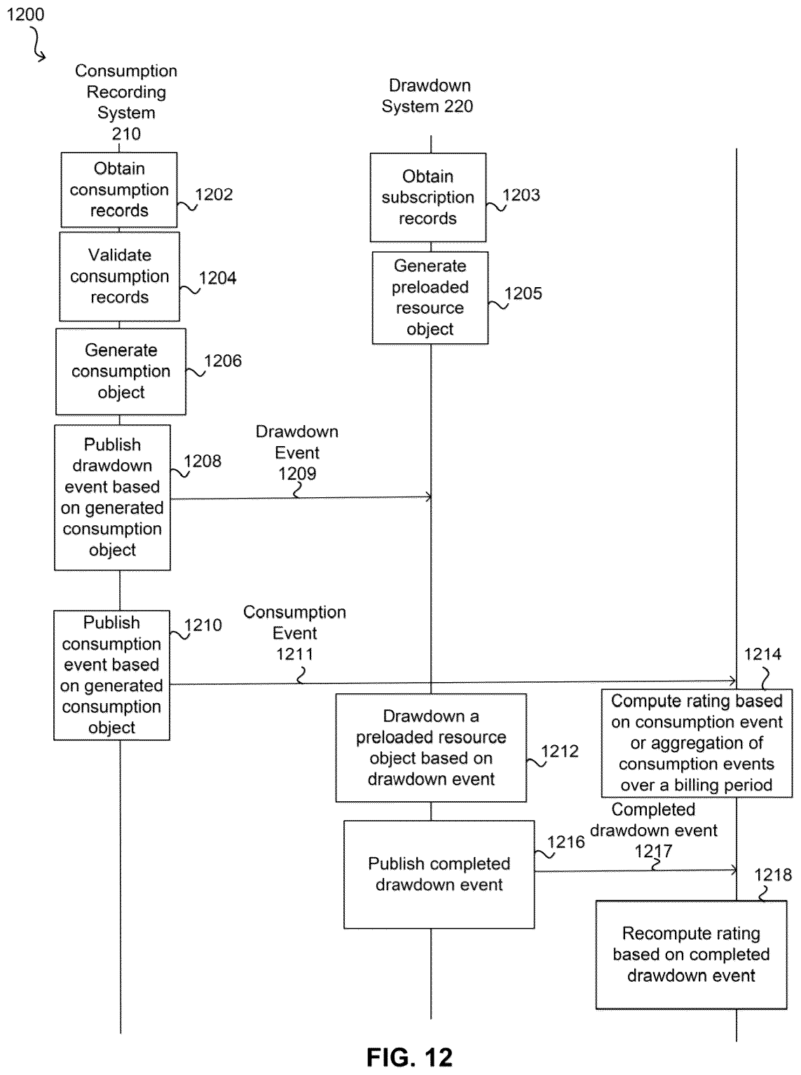

FIG. 12 is an example flow diagram that describes interactions among the consumption recording system 210, the drawdown system 220, and the rating computation system 230, in accordance with some embodiments of the present invention. In step 1202, the consumption recording system 210 obtains the consumption records 209 and the subscription records 207. In step 1204, the consumption recording system 210 validates a particular consumption record (e.g., the consumption record 209) by identifying a particular subscription record (e.g., the subscription record 207) and verifying that the fields 342, 344, 346, and 348 of the particular subscription record match the fields 402, 404, 406, and 412 within a particular consumption record, as previously described in FIG. 6. In step 1206, following the validation of the particular consumption record, the consumption recording system 210 may generate a consumption object (e.g., the consumption object 505). In step 1208, the consumption recording system 210 may publish a drawdown event 1209 to be ingested into the drawdown system 220 via the drawdown event message queue 218, based on the generated consumption object. In step 1210, the consumption recording system 210 may publish a consumption event to be ingested into the rating computation system 230 via the consumption event message queue 228 based on the generated consumption object. It is contemplated that steps 1208 and 1210 may occur at nearly same times and separately. In some embodiments, step 1208 may occur either before or after step 1210.

Moving to the drawdown system 220, in step 1203, the drawdown system 220 may obtain the subscription records 207. The drawdown system 220 may, from the obtained subscription records 207, generate one or more preloaded resource objects in step 1205, based on the preloaded resource parameters 232 of the subscription records 207. The drawdown system 220 may, in step 1212, after obtaining the drawdown event 1209, identify a particular preloaded resource and drawdown the particular preloaded resource based on the drawdown event 1209. The identifying of the particular preloaded resource may be based on the subscription identifier (e.g., the subscription identifier 343) and the drawdown UOM (e.g., the drawdown UOM 379) indicated within the drawdown event 1209. In step 1216, the drawdown system 220 may publish a completed drawdown event 1217 to the rating computation system 230, via the completed drawdown event message queue 229. The completed drawdown event 1217 indicates an amount of a drawdown and/or any remaining overages.

Moving to the rating computation system 230, in step 1214, after obtaining the consumption event 1211, the rating computation system 230 may compute a rating based on the consumption event 1211, or based on an aggregation of consumption events over a billing period. In step 1218, the rating computation system 230 may recompute the rating based on the completed drawdown event 1217.

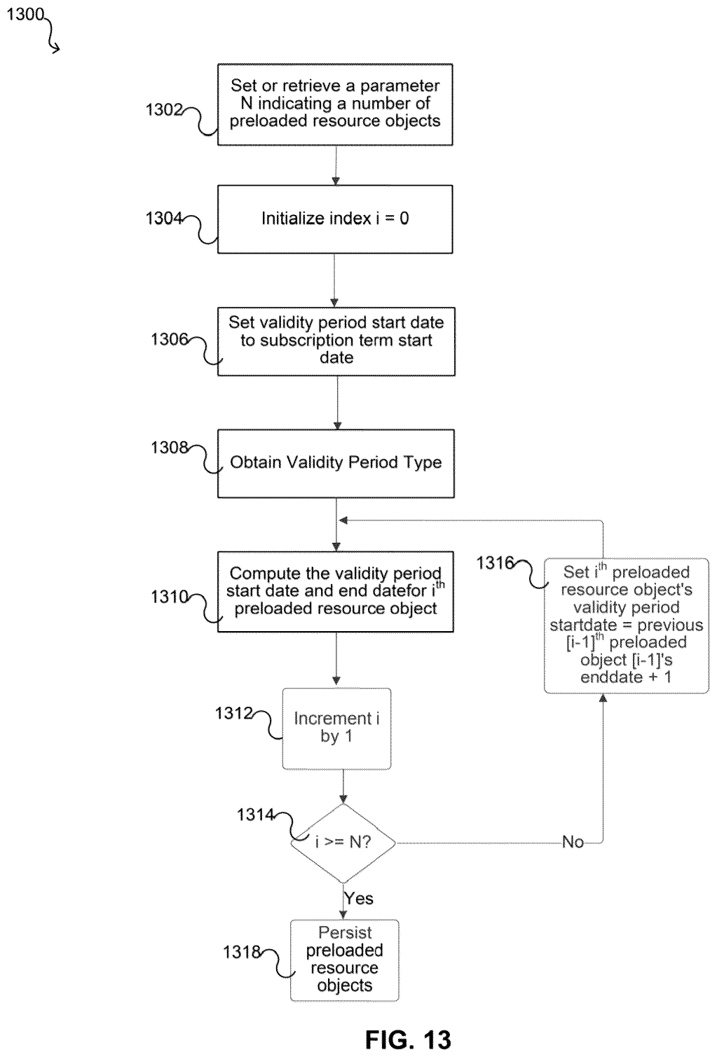

FIG. 13 is a flowchart of a method of creating preloaded resource objects by the drawdown system, in accordance with some embodiments of the present invention. Although the method refers to the drawdown system 220, other database systems besides the drawdown system 220 may also implement the method described. In step 1302, the drawdown system 220 may set or retrieve a parameter, denoted as N, which indicates a number of preloaded resource objects to be created. The parameter may be obtained from any sources such as the datastores 114, the tenant interfaces 110, the server systems 112, and/or any other external systems or APIs. In step 1304, the drawdown system 220 may initialize a tracking index i to an initial value of 0. The tracking index may refer to a particular preloaded resource object (e.g., the preloaded resource object 805) to be created. In step 1306, the drawdown system 220 may set a validity period of the particular preloaded resource object, corresponding to i=0, to have a start date that matches a start date of the subscription term. The drawdown system 220 may obtain such subscription information from any sources such as the datastores 114, the tenant interfaces 110, the server systems 112, and/or any other external systems or APIs. In step 1308, the drawdown system 220 may obtain a validity period type. The validity period type may indicate a duration of a validity period, such as annual, meaning that each preloaded resource object is valid for one year upon creation. In step 1310, the drawdown system 220 may determine the validity period start date and end date for the particular preloaded resource object. This determination may be based on a subscription term, and/or a subscription start date 349 and the subscription end date 351 of the subscription record 207. As an illustrative example, if the validity period type is annual, and the subscription term is also annual, then the validity period start date and end date may be Jan. 1, 2023 and Dec. 31, 2023, respectively. In step 1312, the drawdown system 220 may increment the value of i by one, to transition to a next preloaded resource object to be created. In decision 1314, the drawdown system 220 may determine whether or not the value of i is greater than or equal to N. In response to a negative determination, in step 1316, the drawdown system 220 may set a validity period of the next (e.g., i^{th}) preloaded resource object to start one day after the end date of the previous preloaded resource object. For example, if the validity period of the 0^{th} preloaded resource object is from Jan. 1, 2023, to Dec. 31, 2023, then the validity period of the first preloaded resource object would be from Jan. 1, 2024 to Jan. 31, 2024. In response to a positive determination from decision 1314, the drawdown system 220 may persist the created preloaded resource objects to a database, in step 1318.

In the example flowchart of FIG. 13, none of the validity periods between any two preloaded resource objects overlap. In other embodiments, the validity periods between two preloaded resource objects may at least partially overlap. For example, two preloaded resource objects may each be valid from between Jan. 1, 2023 and Dec. 31, 2023. As another example, one preloaded resource object may be valid from Jan. 1, 2023 and Dec. 31, 2023 and a different preloaded resource object may be valid from Jun. 1, 2023 to May 31, 2024.

In some embodiments, the example flowchart of FIG. 13 may apply to evergreen subscriptions, which do not define an end date of a subscription period. For evergreen subscriptions, N may be defined to be sufficiently large, depending on a validity period type. In some embodiments, N may be set to a larger value if the validity period type is shorter, such as one month as opposed to one year. In other words, if a validity period of a preloaded resource object is only one month, as opposed to one year, then more preloaded resource objects may need to be created. This balances the need for additional preloaded resource objects without generating excess preloaded resource objects, which would take up storage space and consume processing power. If a consumption record (e.g., the consumption record 209) or a drawdown event indicated a distant date such as within the year 3000, the drawdown system 220 would not perform drawdown because the drawdown system 220 would be unable to locate any preloaded resource object having a validity period that includes the year 3000. In some embodiments, the rating computation system 230 may still compute a rating.

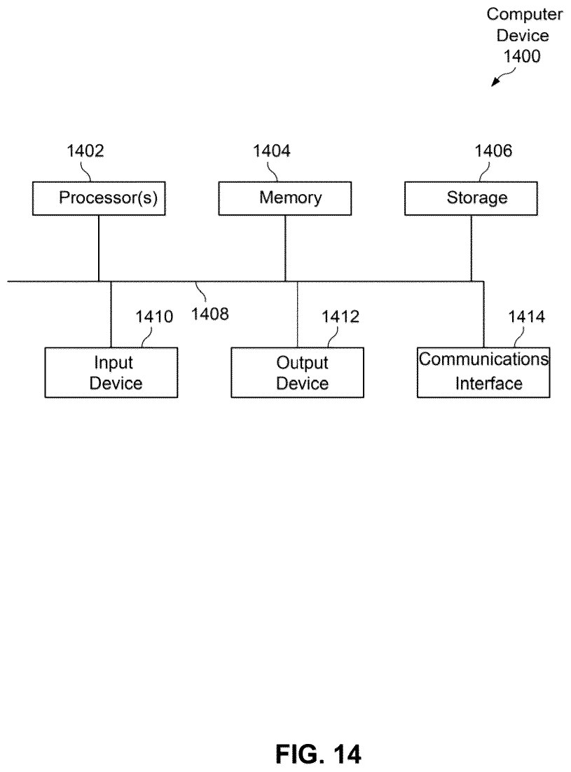

FIG. 14 is a block diagram of a computing device 1400. Any of the systems, engines, datastores, and/or networks described herein may comprise an instance of one or more computing devices 1400. In some embodiments, functionality of the computing device 1400 is improved to perform some or all of the functionality described herein. The computing device 1400 comprises a processor 1402, memory 1404, storage 1406, an input device 1410, a communication network interface 1414, and an output device 1412 communicatively coupled to a communication channel 1408. The processor 1402 is configured to execute executable instructions (e.g., programs). In some embodiments, the processor 1402 comprises circuitry or any processor capable of processing the executable instructions.

The memory 1404 stores data. Some examples of memory 1404 include storage devices, such as RAM, ROM, RAM cache, virtual memory, etc. In various embodiments, working data is stored within the memory 1404. The data within the memory 1404 may be cleared or ultimately transferred to the storage 1406.

The storage 1406 includes any storage configured to retrieve and store data. Some examples of the storage 1406 include flash drives, hard drives, optical drives, cloud storage, and/or magnetic tape. In some embodiments, storage 1406 may include RAM. Each of the memory 1404 and the storage 1406 comprises a computer-readable medium, which stores instructions or programs executable by processor 1402.

The input device 1410 may be any device that inputs data (e.g., mouse and keyboard). The output device 1412 may be any device that outputs data and/or processed data (e.g., a speaker or display). It will be appreciated that the storage 1406, input device 1410, and output device 1412 may be optional. For example, the routers/switchers may comprise the processor 1402 and memory 1404 as well as a device to receive and output data (e.g., the communication network interface 1414 and/or the output device 1412).

The communication network interface 1414 may be coupled to a network (e.g., the network system 100) via the link 1408. The communication network interface 1414 may support communication over an Ethernet connection, a serial connection, a parallel connection, and/or an ATA connection. The communication network interface 1414 may also support wireless communication (e.g., 802.11 a/b/g/n, WiMax, LTE, WiFi). It will be apparent that the communication network interface 1414 may support many wired and wireless standards.

It will be appreciated that the hardware elements of the computing device 1400 are not limited to those depicted. A computing device 1400 may comprise more or less hardware, software and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 1402 and/or a co-processor located on a GPU (i.e., NVidia).

It will be appreciated that an “engine,” “system,” “datastore,” and/or “database” may comprise software, hardware, firmware, service, microservice, and/or circuitry. In one example, one or more software programs comprising instructions capable of being executable by a processor may perform one or more of the functions of the engines, datastores, databases, or systems described herein. In another example, circuitry may perform the same or similar functions. Alternative embodiments may comprise more, less, or functionally equivalent engines, systems, datastores, or databases, and still be within the scope of present embodiments. For example, the functionality of the various systems, engines, datastores, and/or databases may be combined or divided differently. The datastore or database may include cloud storage. It will further be appreciated that the term “or” as used herein, may be construed in either an inclusive or exclusive sense. Moreover, plural instances may be provided for resources, operations, or structures described herein as a single instance. It will be appreciated that the term “request” shall include any computer request or instruction, whether permissive or mandatory.

The databases/datastores described herein may be any suitable structure (e.g., an active database, a relational database, a self-referential database, a table, a matrix, an array, a flat file, a documented-oriented storage system, a non-relational No-SQL system, and the like), and may be cloud-based or otherwise. References to objects may refer to data representations that include fields and/or attributes that define the data.

The systems, methods, engines, datastores, and/or databases described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The present invention(s) are described above with reference to example embodiments. It will be apparent to those skilled in the art that various modifications may be made and other embodiments may be used without departing from the broader scope of the present invention(s). Therefore, these and other variations upon the example embodiments are intended to be covered by the present invention(s).

1. A multi-tenant system, comprising:
one or more hardware processors; and
memory storing computer instructions, the computer instructions when executed by the one or more hardware processors configured to perform:
in a drawdown system:
obtaining one or more subscription records, the one or more subscription records comprising subscription record fields indicative of subscription identification parameters and preloaded resource parameters, the subscription identification parameters identifying a subscriber of a tenant and a particular subscription resource to which the subscriber has a subscription, and the preloaded resource parameters defining a preloaded resource object that has a preloaded allocation of the particular subscription resource;
obtaining one or more drawdown events from a drawdown event message queue, each of the one or more drawdown events comprising drawdown event fields indicative of a consumption quantity and a first subset of the subscription identification parameters of a particular subscription record;
identifying a particular preloaded resource object to be drawn down from based on the drawdown event;
performing a selective drawdown on the particular preloaded resource object according to the one or more drawdown events; and
publishing a completed drawdown event within a completed drawdown message queue in response to performing of the selective drawdown;
in a rating computation system, each of the rating computation system and the drawdown system being independently scalable relative to each other:
obtaining the one or more subscription records;
obtaining one or more consumption events from a consumption event message queue, each of the one or more consumption events comprising consumption event fields indicative of the consumption quantity and the first subset or a second subset of the subscription identification parameters of the particular subscription record;
computing a rating based on the one or more consumption events and the particular subscription record;
obtaining the completed drawdown event; and
adjusting the computed rating based on the completed drawdown event.

2. The multi-tenant system of claim 1, wherein the computer instructions when executed by the one or more hardware processors configured to perform:
independently adjusting a throughput of events transmitted through the drawdown event message queue and the consumption event message queue.

3. The multi-tenant system of claim 1, wherein the drawdown event fields comprise a charge identifier field indicative of the particular subscription resource; and the computer instructions when executed by the one or more hardware processors configured to perform:
partitioning the drawdown event message queue and the consumption event message queue into separate partitions based on the charge identifier field.

4. The multi-tenant system of claim 1, wherein the subscription records comprise termed subscriptions or evergreen subscriptions.

5. The multi-tenant system of claim 1, wherein the identifying of the particular preloaded resource object comprises:
obtaining a drawdown unit of measure (UOM) mapped by the drawdown event; and
determining the particular preloaded resource object having a preloading UOM that matches the drawdown UOM.

6. The multi-tenant system of claim 1, wherein the adjusting of the computed rating based on the completed drawdown event is performed in a roll forward manner, the adjusting of the computed rating comprising appending an adjustment entry which negates the computed rating and an adjusted entry indicating an adjusted rating.

7. The multi-tenant system of claim 1, wherein the performing of the selective drawdown on the particular preloaded resource object comprises:
determining an available quantity of the subscription resource recorded within the particular preloaded resource object; and
deducting the available quantity by the consumption quantity.

8. The multi-tenant system of claim 7, wherein the performing of the selective drawdown on the particular preloaded resource object comprises:
determining that the consumption quantity exceeds the available quantity; and
in response to determining that the consumption quantity exceeds the available quantity, recording an overage corresponding to the difference between the consumption quantity and the available quantity, wherein the completed drawdown event comprises the overage.

9. The multi-tenant system of claim 8, wherein the adjusting of the computed rating comprises adjusting the computed rating to an adjusted rating indicative of the overage.

10. The multi-tenant system of claim 7, wherein the performing of the selective drawdown on the particular preloaded resource object comprises:
determining that the consumption quantity exceeds the available quantity; and
in response to determining that the consumption quantity exceeds the available quantity:
identifying any other particular preloaded resource objects to be drawn down from based on the drawdown event; and
performing a selective drawdown of the any other particular preloaded resource objects according to the consumption quantity.

11. A method implemented by a multi-tenant system, the method comprising:
in a drawdown system:
obtaining one or more subscription records, the one or more subscription records comprising subscription record fields indicative of subscription identification parameters and preloaded resource parameters, the subscription identification parameters identifying a subscriber of a tenant and a particular subscription resource to which the subscriber has a subscription, and the preloaded resource parameters defining a preloaded resource object that has a preloaded allocation of the particular subscription resource;
obtaining one or more drawdown events from a drawdown event message queue, each of the one or more drawdown events comprising drawdown event fields indicative of a consumption quantity and a first subset of the subscription identification parameters of a particular subscription record;
identifying a particular preloaded resource object to be drawn down from based on the drawdown event;
performing a selective drawdown on the particular preloaded resource object according to the one or more drawdown events; and
publishing a completed drawdown event within a completed drawdown message queue in response to performing of the selective drawdown;
in a rating computation system, each of the rating computation system and the drawdown system being independently scalable relative to each other:
obtaining the one or more subscription records;
obtaining one or more consumption events from a consumption event message queue, each of the one or more consumption events comprising consumption event fields indicative of the consumption quantity and the first subset or a second subset of the subscription identification parameters of the particular subscription record;
computing a rating based on the one or more consumption events and the particular subscription record;
obtaining the completed drawdown event; and
adjusting the computed rating based on the completed drawdown event.

12. The method of claim 11, further comprising:
independently adjusting a throughput of events transmitted through the drawdown event message queue and the consumption event message queue.

13. The method of claim 11, wherein the drawdown event fields comprise a charge identifier field indicative of the particular subscription resource; the method further comprising partitioning the drawdown event message queue and the consumption event message queue into separate partitions based on the charge identifier field.

14. The method of claim 11, wherein the subscription records comprise termed subscriptions or evergreen subscriptions.

15. The method of claim 11, wherein the identifying of the particular preloaded resource object comprises:
obtaining a drawdown unit of measure (UOM) mapped by the drawdown event; and
determining the particular preloaded resource object having a preloading UOM that matches the drawdown UOM.

16. The method of claim 11, wherein the adjusting of the computed rating based on the completed drawdown event is performed in a roll forward manner, the adjusting of the computed rating comprising appending an adjustment entry which negates the computed rating and an adjusted entry indicating an adjusted rating.

17. The method of claim 11, wherein the performing of the selective drawdown on the particular preloaded resource object comprises:
determining an available quantity of the subscription resource recorded within the particular preloaded resource object; and
deducting the available quantity by the consumption quantity.

18. The method of claim 17, wherein the performing of the selective drawdown on the particular preloaded resource object comprises:
determining that the consumption quantity exceeds the available quantity; and
in response to determining that the consumption quantity exceeds the available quantity, recording an overage corresponding to the difference between the consumption quantity and the available quantity, wherein the completed drawdown event comprises the overage.

19. The method of claim 18, wherein the adjusting of the computed rating comprises adjusting the computed rating to an adjusted rating indicative of the overage.

20. The method of claim 17, wherein the performing of the selective drawdown on the particular preloaded resource object comprises:
determining that the consumption quantity exceeds the available quantity; and
in response to determining that the consumption quantity exceeds the available quantity:
identifying any other particular preloaded resource objects to be drawn down from based on the drawdown event; and
performing a selective drawdown of the any other particular preloaded resource objects according to the consumption quantity.
